(19) United States
(12) Patent Application Publication
(10) Pub. No.: US 2026/0046502 A1
(43) Pub. Date: Feb. 12, 2026

(54) IMAGING APPARATUS

(71) Applicant: Panasonic Intellectual Property Management Co., Ltd., Osaka (JP)

(72) Inventor: Kenji NISHIWAKI, Hyogo (JP)

(73) Assignee: Panasonic Intellectual Property Management Co., Ltd., Osaka (JP)

(21) Appl. No.: 19/286,316

(22) Filed: Jul. 31, 2025

(30) Foreign Application Priority Data
Aug. 9, 2024 (JP) 2024-134280

(51) Int. Cl. H04N 23/53; H04N 23/51

(52) U.S. Cl. CPC H04N 23/53; H04N 23/51

(57) ABSTRACT

An imaging apparatus includes: a housing including an upper surface, a front surface, and a rear surface; an imaging sensor configured to capture a subject image existing in front of the front surface via an optical system to generate imaging data; a first monitor including a display screen; a position adjustment mechanism configured to movably couple the first monitor to the housing and be capable of adjusting a position of the first monitor with respect to the housing to a plurality of positions; and a user interface provided on the rear surface of the housing. The plurality of positions includes a first position where the first monitor overlaps the rear surface of the housing in a state where the user interface is covered and hidden by the first monitor.

### BACKGROUND

### Technical Field

The present disclosure relates to an imaging apparatus including a monitor.

### Description of the Related Art

Conventionally, as described in JP 2017-85205 A, there has been known an imaging apparatus in which a monitor is provided so as to be disposed at various positions with respect to a housing.

### SUMMARY

An object of the present disclosure is to, in an imaging apparatus including a monitor, enable the monitor to be disposed at various positions with respect to a housing suitable for photographing, editing, and the like.

In order to solve the above problem, according to an aspect of the present disclosure, an imaging apparatus is provided that includes:
a housing including an upper surface, a front surface, and a rear surface;
an imaging sensor configured to capture a subject image existing in front of the front surface via an optical system to generate imaging data;
a first monitor including a display screen;
a position adjustment mechanism configured to movably couple the first monitor to the housing and be capable of adjusting a position of the first monitor with respect to the housing to a plurality of positions; and
a user interface provided on the rear surface of the housing,
wherein the plurality of positions includes a first position where the first monitor overlaps the rear surface of the housing in a state where the user interface is covered and hidden by the first monitor.

According to the present disclosure, in an imaging apparatus including a monitor, the monitor can be disposed at various positions with respect to a housing suitable for photographing, editing, and the like.

### BRIEF DESCRIPTION OF DRAWINGS

FIG. 1 is a front perspective view of an imaging apparatus according to one embodiment of the present disclosure;

FIG. 2 is a rear perspective view of the imaging apparatus;

FIG. 3 is a rear perspective view of the imaging apparatus as viewed from a direction different from FIG. 2;

FIG. 4 is a side view of the imaging apparatus;

FIG. 5 is an exploded perspective view of the imaging apparatus schematically illustrating a monitor arm mechanism that couples a housing and a first monitor;

FIG. 6 is a perspective view illustrating the first monitor that slides by a slide mechanism;

FIG. 7A is a partial cross-sectional view of the imaging apparatus in a state where the first monitor is disposed at a first position;

FIG. 7B is a rear view of the imaging apparatus corresponding to FIG. 7A;

FIG. 8A is a perspective view of the imaging apparatus in a state where the first monitor is disposed at a second position;

FIG. 8B is a partial cross-sectional view of the imaging apparatus corresponding to FIG. 8A;

FIG. 8C is a rear view of the imaging apparatus corresponding to FIG. 8A;

FIG. 9A is a perspective view of the imaging apparatus in a state where the first monitor is disposed at a third position;

FIG. 9B is a partial cross-sectional view of the imaging apparatus corresponding to FIG. 9A;

FIG. 10A is a perspective view of the imaging apparatus in a state where the first monitor is disposed at a fourth position;

FIG. 10B is a partial cross-sectional view of the imaging apparatus corresponding to FIG. 10A;

FIG. 11A is a perspective view of the imaging apparatus in a state where the first monitor is disposed at a fifth position;

FIG. 11B is a partial cross-sectional view of the imaging apparatus corresponding to FIG. 11A;

FIG. 12A is a view illustrating an example of a display screen of the first monitor and a display screen of a second monitor;

FIG. 12B is a view illustrating another example of a display screen of the first monitor and a display screen of the second monitor;

FIG. 12C is a view illustrating still another example of a display screen of the first monitor and a display screen of the second monitor;

FIG. 13 is a rear view of the imaging apparatus in a state where a user interface on a rear surface of the housing is displayed on the first monitor as an icon image;

FIG. 14A is a schematic view of the imaging apparatus according to another embodiment in a state where the first monitor is disposed at the first position;

FIG. 14B is a schematic view of the imaging apparatus according to another embodiment in a state where the first monitor is disposed at the second position or the third position.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that, the inventor(s) provide the accompanying drawings and the following description for those skilled in the art to fully understand the present disclosure, and do not intend to limit the subject matter described in the claims by the accompanying drawings and the following description.

Hereinafter, an imaging apparatus according to an embodiment of the present disclosure will be described with reference to the drawings.

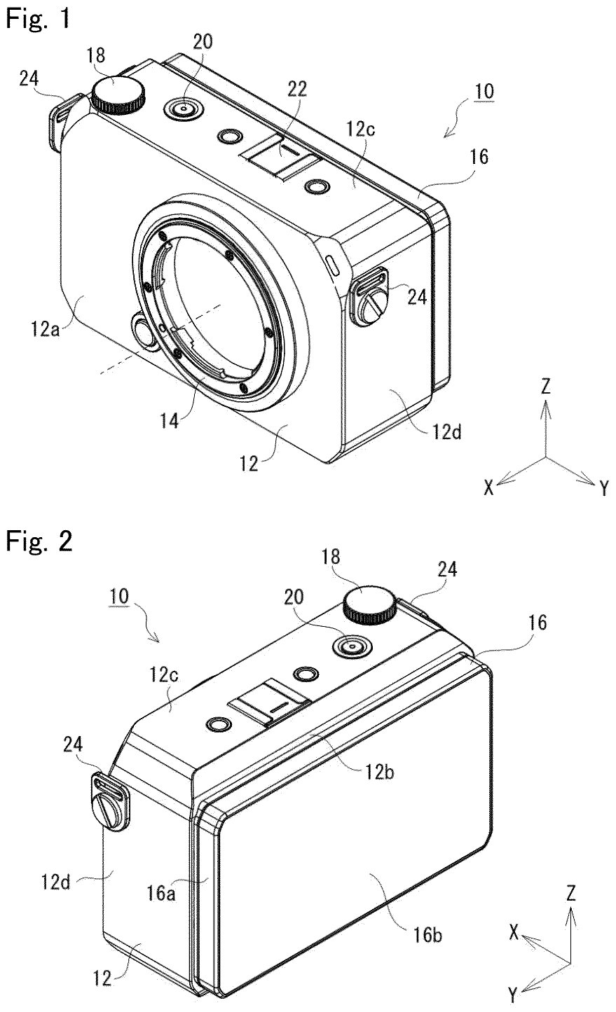

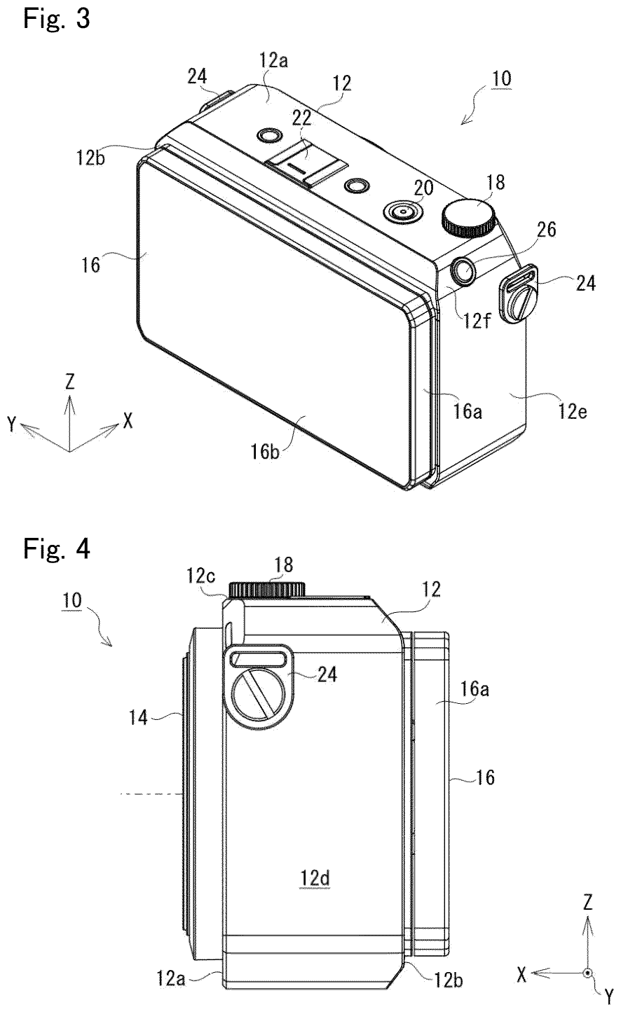

FIG. 1 is a front perspective view of an imaging apparatus according to one embodiment of the present disclosure. FIG. 2 is a rear perspective view of the imaging apparatus. FIG. 3 is a rear perspective view of the imaging apparatus as viewed from a direction different from FIG. 2. FIG. 4 is a side view of the imaging apparatus.

Note that, the X-Y-Z orthogonal coordinate system illustrated in the drawings is for facilitating understanding of the embodiment of the present disclosure, and does not limit the embodiment of the present disclosure. The X-axis direction is a front-rear direction of the imaging apparatus, the Y-axis direction is a left-right direction, and the Z-axis direction is a height direction. In addition, in the present specification, the side of the imaging apparatus on which a subject is present is referred to as “front side”, and the side on which the imaging apparatus is present is referred to as “rear side”.

As illustrated in FIGS. 1 to 4, an imaging apparatus 10 according to the present embodiment includes a housing 12 having a substantially rectangular parallelepiped shape. The housing 12 includes a front surface 12a facing a subject at the time of photographing, a rear surface 12b opposite to the front surface 12a, an upper surface 12c connecting the front surface 12a and the rear surface 12b, a left side surface 12d, and a right side surface 12e.

A lens mount 14 to which a lens-barrel (not illustrated) is detachably attached is provided on the front surface 12a of the housing 12. Although details will be described later, a first monitor 16 is provided on the rear surface 12b of the housing 12 so as to be movable with respect to the housing 12. A dial 18, a power button 20, an accessory shoe 22, and the like are provided on the upper surface 12c of the housing 12. A strap attachment fitting 24 for attaching a strap is provided on each of the left side surface 12d and the right side surface 12e of the housing 12. In addition, in the case of the present embodiment, a recording button 26 is provided on a tapered surface 12f between the upper surface 12c and the right side surface 12e.

The first monitor 16 includes a casing 16a having a thin rectangular parallelepiped shape and a display screen 16b provided on the casing 16a. The first monitor 16 displays various information on the display screen 16b. For example, the first monitor 16 displays (live-view display) imaging data of a subject image formed on an imaging sensor (not illustrated) in the housing 12 through an optical system including a lens-barrel attached to the lens mount 14, that is, displays the imaging data generated by the imaging sensor. In addition, for example, the first monitor 16 displays information necessary for a user to set the photographing condition. Furthermore, for example, the first monitor 16 displays imaging data such as a photographed image and a photographed moving image recorded in a storage device (not illustrated) in the housing 12.

Note that, in the case of the present embodiment, the first monitor 16 is a touch screen monitor. That is, the first monitor 16 functions as an output device that provides information to the user and functions as an input device that receives an instruction input of the user.

The first monitor 16 is also provided on the housing 12 so as to be movable with respect to the housing 12, that is, so as to be adjustable a position with respect to the housing 12 to a plurality of positions. Specifically, via a monitor arm mechanism, the first monitor 16 is coupled to the housing 12 so as to be movable with respect to the housing 12.

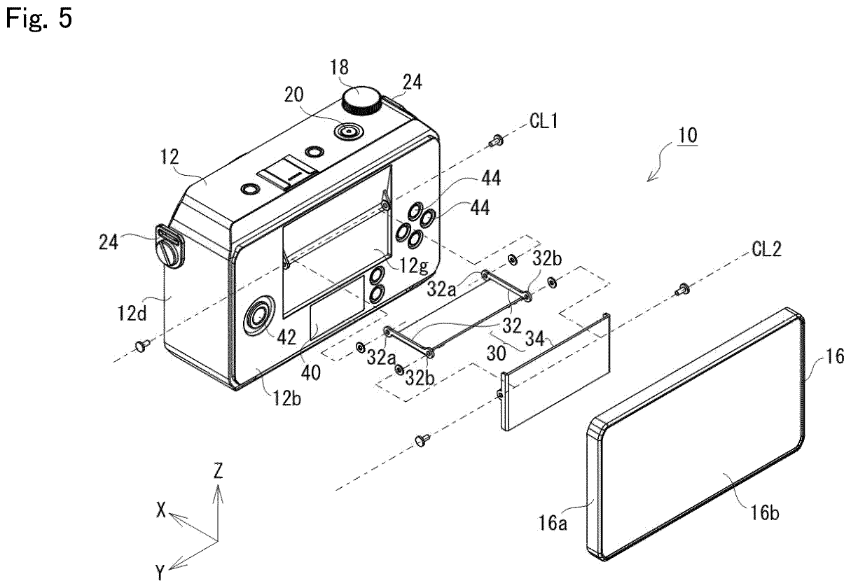

FIG. 5 is an exploded perspective view of the imaging apparatus schematically illustrating the monitor arm mechanism that couples the housing and the first monitor.

In the case of the present embodiment, as illustrated in FIG. 5, a monitor arm mechanism 30 is a position adjustment mechanism that adjusts the position of the first monitor 16 with respect to the housing 12 to a plurality of positions, and includes two link arms 32 that are provided on the rear surface 12b of the housing 12 and couple the housing 12 and the first monitor 16, and a slide mechanism 34 that slidably supports the first monitor 16.

Each of the two link arms 32 of the monitor arm mechanism 30 includes one end 32a supported by the housing 12 so as to be rotatable about a first rotation center line CL1 extending in the left-right direction (Y-axis direction) of the housing 12, and the other end 32b supported by the slide mechanism 34 so as to be rotatable about a second rotation center line CL2 parallel to the first rotation center line CL1. The two link arms 32 are coupled to each other. In addition, the link arm 32 is coupled to the housing 12 and the slide mechanism 34 via, for example, a torque hinge (not illustrated). The torque hinge fixes the rotation angle of the link arm 32 with respect to the housing 12 and the slide mechanism 34 at an arbitrary angle.

The slide mechanism 34 of the monitor arm mechanism 30 slidably (movably in parallel) supports the first monitor 16.

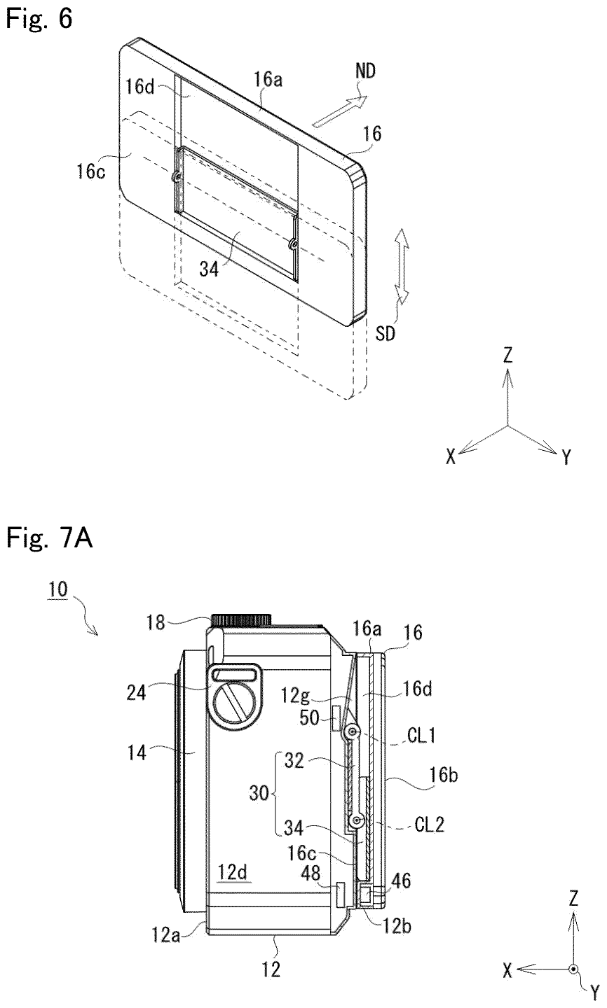

FIG. 6 is a perspective view illustrating the first monitor that slides by a slide mechanism.

As illustrated in FIG. 6, the slide mechanism 34 of the monitor arm mechanism 30 is housed in a recess 16d formed on a back surface 16c (a surface opposite to the display screen 16b) of the casing 16a of the first monitor 16. In addition, the slide mechanism 34 supports the first monitor 16 slidably in a direction SD orthogonal to both a normal direction ND of the display screen 16b and an extending direction (Y-axis direction) of the second rotation center line CL2.

According to the monitor arm mechanism 30 having such a structure, the user can arrange the first monitor 16 at a plurality of positions with respect to the housing 12 and can take a plurality of postures.

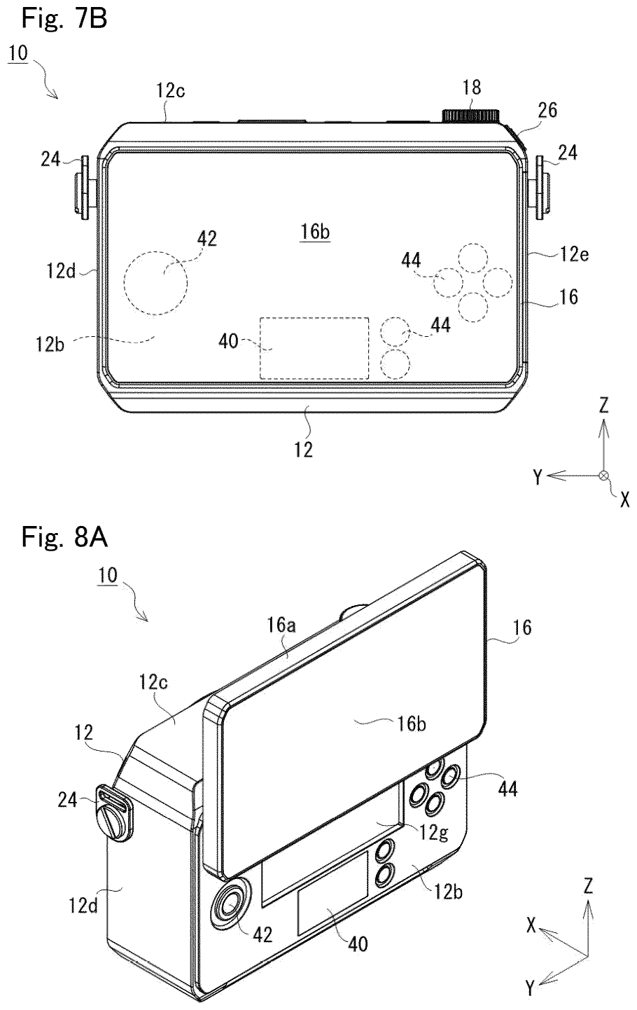

FIG. 7A is a partial cross-sectional view of the imaging apparatus in a state where the first monitor is disposed at a first position. In addition, FIG. 7B is a rear view of the imaging apparatus corresponding to FIG. 7A. FIGS. 7A and 7B correspond to FIGS. 1 to 4.

As illustrated in FIGS. 7A and 7B and as illustrated in FIGS. 2 to 4, the monitor arm mechanism 30 allows the first monitor 16 to be disposed at the first position overlapping the rear surface 12b of the housing 12 as one position among the plurality of positions. In the case of the present embodiment, when the first monitor 16 is disposed at the first position, the display screen 16b of the first monitor 16 faces rearward. In the case of the present embodiment, the first monitor 16 has a size capable of covering the entire rear surface 12b of the housing 12 when being disposed at the first position. Note that, the first monitor 16 disposed at the first position is hidden behind the housing 12 and is not visible when viewed from the front surface 12a side of the imaging apparatus 10.

As illustrated in FIGS. 5 and 7A, when the first monitor 16 is disposed at the first position, the link arm 32 of the monitor arm mechanism 30 is stored in a recess 12g formed on the rear surface 12b of the housing 12. As a result, the back surface 16c of the first monitor 16 can be seated on the rear surface 12b of the housing 12.

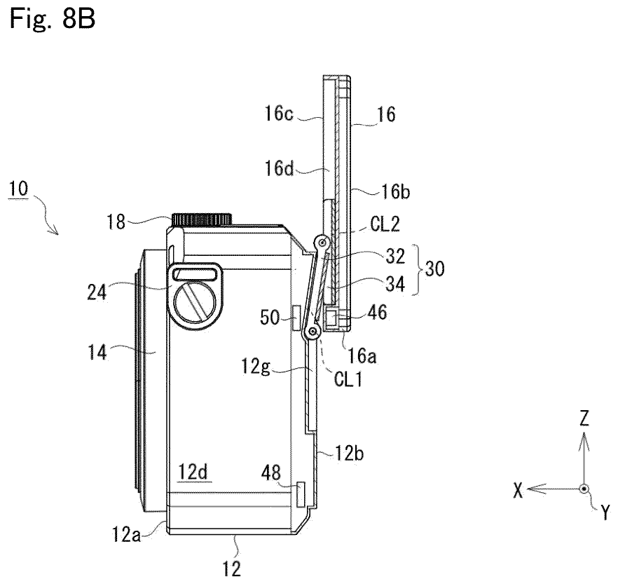

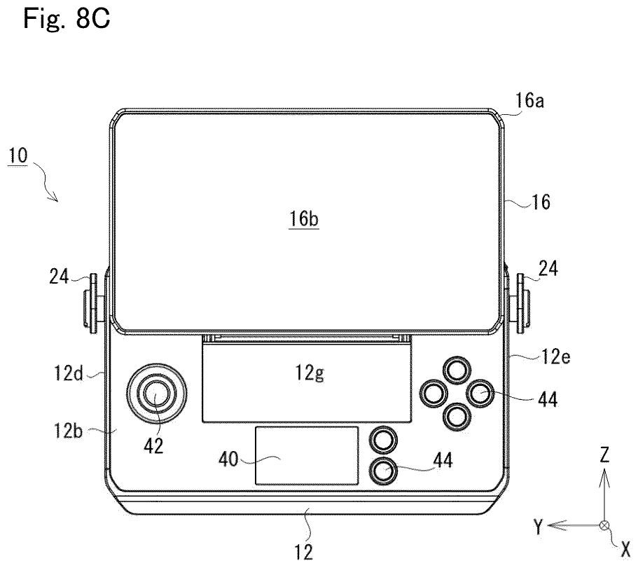

FIG. 8A is a perspective view of the imaging apparatus in a state where the first monitor is disposed at a second position. In addition, FIG. 8B is a partial cross-sectional view of the imaging apparatus corresponding to FIG. 8A. Then, FIG. 8C is a rear view of the imaging apparatus corresponding to FIG. 8A.

As illustrated in FIGS. 8A to 8C, the monitor arm mechanism 30 allows the first monitor 16 to be disposed at the second position overlapping a portion of the rear surface 12b of the housing 12 as one position among the plurality of positions. In the case of the present embodiment, the first monitor 16 disposed at the second position overlaps a region above the rear surface 12b of the housing 12. That is, at this time, a region below the rear surface 12b of the housing 12 is exposed. In addition, in the case of the present embodiment, when the first monitor 16 is disposed at the second position, the display screen 16b of the first monitor 16 faces rearward.

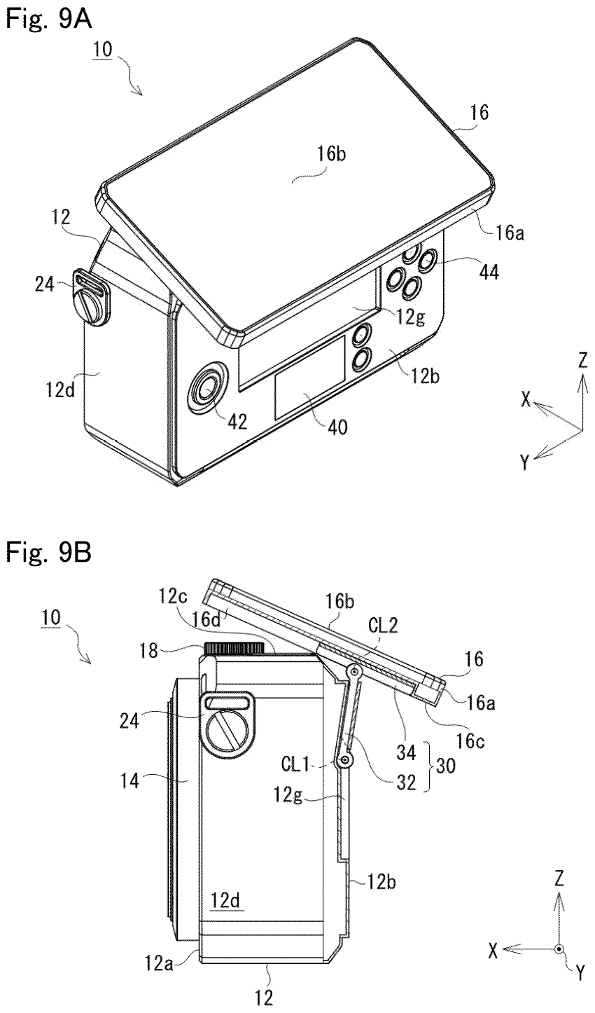

FIG. 9A is a perspective view of the imaging apparatus in a state where the first monitor is disposed at a third position. In addition, FIG. 9B is a partial cross-sectional view of the imaging apparatus corresponding to FIG. 9A.

As illustrated in FIGS. 9A and 9B, the monitor arm mechanism 30 allows the first monitor 16 to be disposed at the third position overlapping the upper surface 12c of the housing 12 as one position among the plurality of positions. In the case of the present embodiment, when the first monitor 16 is disposed at the third position, the display screen 16b of the first monitor 16 faces substantially upward (strictly, obliquely upward and rearward).

Note that, the dial 18 and the recording button 26, which can be frequently operated, are disposed in a portion of the housing 12 close to the right side surface 12e as illustrated in FIG. 3 so as to be able to be easily operated with the fingertip of the right hand even in a state where the first monitor 16 is disposed at the third position overlapping the upper surface 12c of the housing 12.

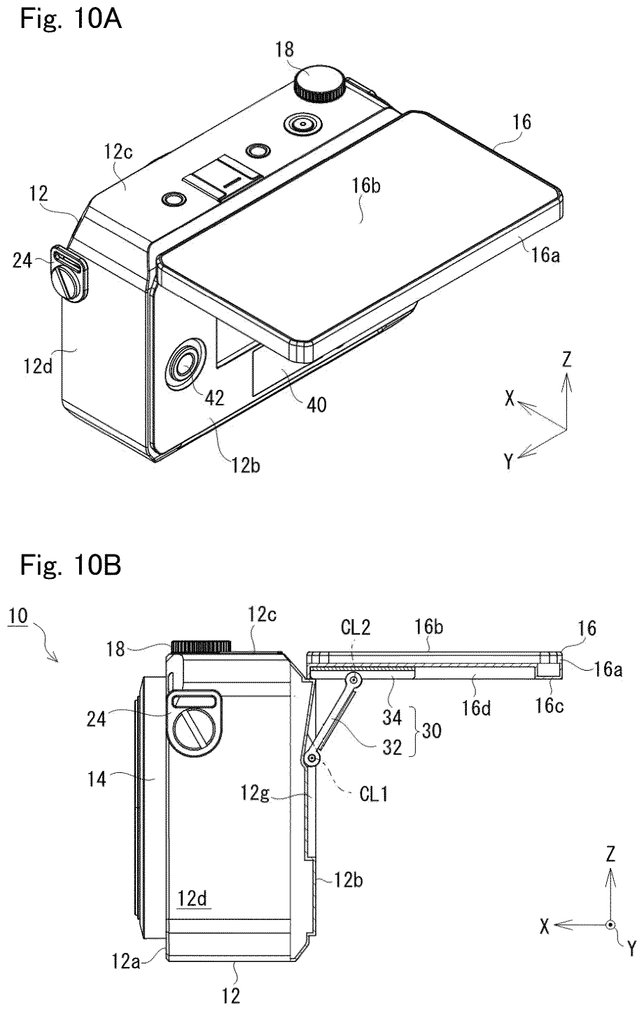

FIG. 10A is a perspective view of the imaging apparatus in a state where the first monitor is disposed at a fourth position. In addition, FIG. 10B is a partial cross-sectional view of the imaging apparatus corresponding to FIG. 10A.

As illustrated in FIGS. 10A and 10B, the monitor arm mechanism 30 allows the first monitor 16 to be disposed at the fourth position where the display screen 16b faces upward without overlapping the upper surface 12c of the housing 12 as one position among the plurality of positions.

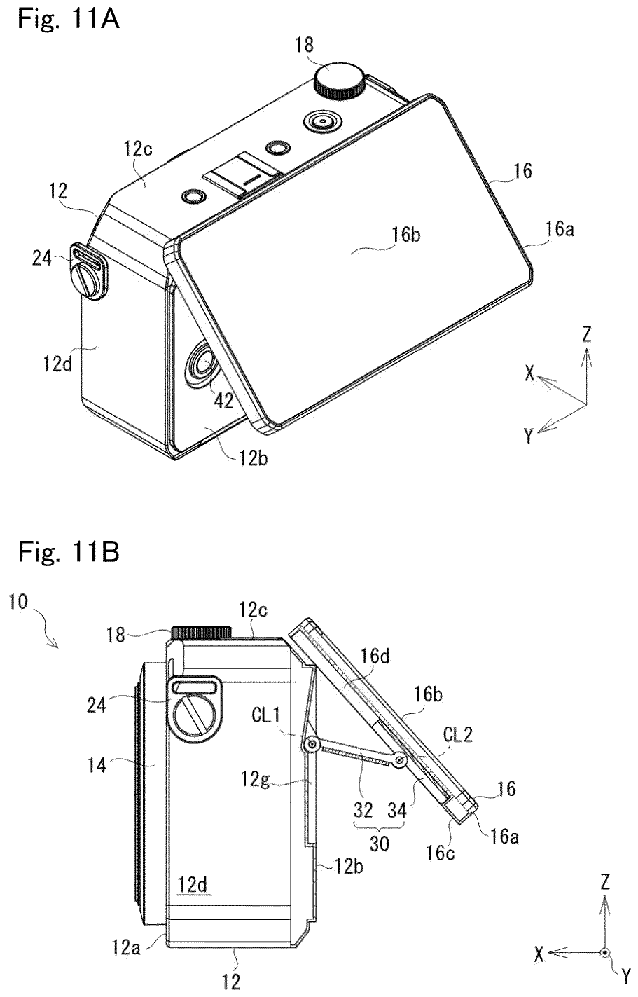

FIG. 11A is a perspective view of the imaging apparatus in a state where the first monitor is disposed at a fifth position. In addition, FIG. 11B is a partial cross-sectional view of the imaging apparatus corresponding to FIG. 11A.

As illustrated in FIG. 11 A and 11B, the monitor arm mechanism 30 allows the first monitor 16 to be disposed, as one position among the plurality of positions, at the fifth position where the display screen 16b faces obliquely upward and rearward without overlapping the upper surface 12c of the housing 12.

Of course, the above-described first to fifth positions are merely examples, and the first monitor 16 can be disposed at positions other than the first to fifth positions via the monitor arm mechanism 30. As illustrated in FIGS. 7A, 9B, 10B, and 11B, the casing 16a of the first monitor 16 located at the first and third to fifth positions is in contact with the housing 12. However, as illustrated in FIG. 8B, the first monitor 16 can also be disposed at various positions without the casing 16a of the first monitor 16 contacting the housing 12.

As illustrated in FIG. 5, not only the monitor arm mechanism 30 but also some user interfaces are provided on the rear surface 12b of the housing 12. In the case of the present embodiment, as the user interface, a second monitor 40, a joystick 42, and a plurality of buttons 44 are provided on the rear surface 12b of the housing 12.

The user interface including the second monitor 40, the joystick 42, and the plurality of buttons 44 provided on the rear surface 12b of the housing 12 is covered and hidden by the first monitor 16 when the first monitor 16 is located at the first position overlapping the entire rear surface 12b of the housing 12, as illustrated in FIG. 7B. That is, the user cannot operate the joystick 42 and the plurality of buttons 44 and cannot view the second monitor 40.

In addition, the user interface including the second monitor 40, the joystick 42, and the plurality of buttons 44 is provided in a region below the rear surface 12b of the housing 12. Therefore, as illustrated in FIGS. 8A to 8C, when the first monitor 16 is located at the second position overlapping the upper portion of the rear surface 12b of the housing 12, the second monitor 40, the joystick 42, and the plurality of buttons 44 are exposed without being covered by the first monitor 16. That is, the user can operate the joystick 42 and the plurality of buttons 44 and view the second monitor 40.

Note that, of course, when the first monitor 16 is located at a position (for example, the third to fifth positions illustrated in FIGS. 9A to 11B) away from the rear surface 12b of the housing 12, the user can access the user interface including the second monitor 40, the joystick 42, and the plurality of buttons 44 provided on the rear surface 12b of the housing 12.

The structure of the imaging apparatus 10 according to the present embodiment has been described above. Further features of the imaging apparatus 10 according to the present embodiment will be described below. In particular, features associated with the second monitor 40, the joystick 42, and the button 44 will be described.

In the case of the present embodiment, as illustrated in FIG. 7B, the second monitor 40 is smaller than the first monitor 16. In addition, in the case of the present embodiment, the second monitor 40 is a monitor that does not include a touch screen, unlike the first monitor 16 that is a touch screen monitor. Furthermore, the second monitor 40 may be covered by the first monitor 16. Therefore, the first monitor 16 is used as a main monitor, and the second monitor 40 is used as a sub monitor. Note that, the second monitor 40 may also be a touch screen monitor similarly to the first monitor 16.

When the user performs a photographing work, a control unit (not illustrated) mounted on the imaging apparatus 10 and including a processor such as a CPU and a storage device such as a memory that stores a program for operating the processor live-view displays imaging data of a subject image on the display screen 16b of the first monitor 16. At that time, as illustrated in FIG. 8B, in a case where the second monitor 40 is not in a state of being covered by the first monitor 16, the control unit of the imaging apparatus 10 displays, on the second monitor 40, information related to photographing (photographing related information), that is, information for assisting the photographing work of the user.

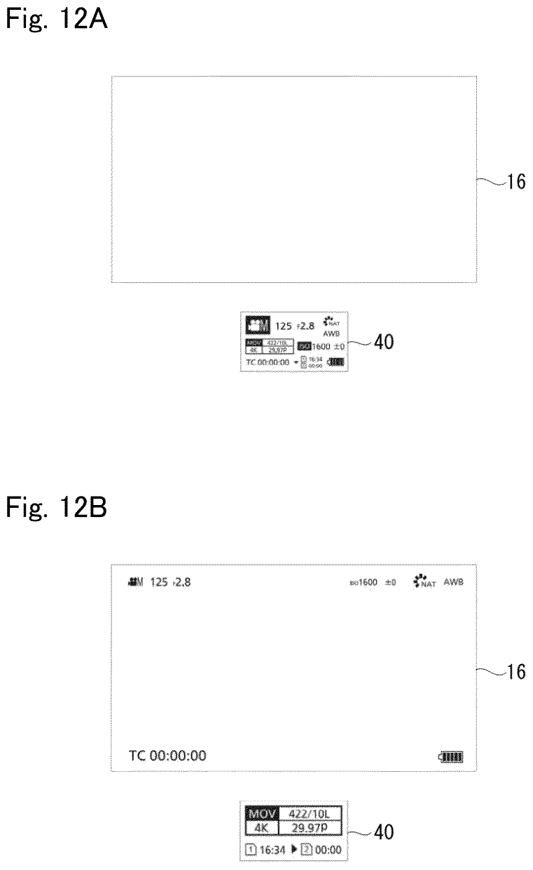

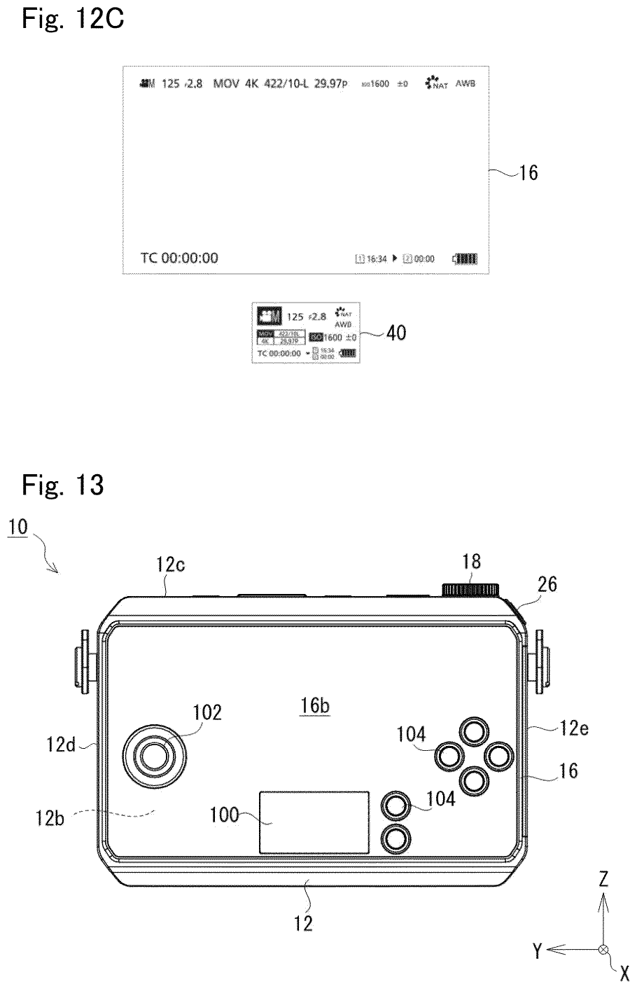

FIG. 12A is a view illustrating an example of a display screen of the first monitor and a display screen of the second monitor. In addition, FIG. 12B is a view illustrating another example of the display screen of the first monitor and the display screen of the second monitor. Then, FIG. 12C is a view illustrating still another example of the display screen of the first monitor and the display screen of the second monitor.

As illustrated in FIG. 12A, for example, the control unit of the imaging apparatus 10 displays only the imaging data of the subject image on first monitor 16, and does not display the photographing related information on the display screen of the first monitor 16. The control unit of the imaging apparatus 10 displays the photographing related information on the display screen of the second monitor 40. The photographing related information includes, for example, an elapsed time (TC) from the start of moving image photographing, remaining battery charge, and photographing conditions such as resolution.

In addition, for example, as illustrated in FIG. 12B, the control unit of the imaging apparatus 10 displays, on the first monitor 16, part of the photographing related information with a high confirmation frequency by the user together with the imaging data of the subject image. For example, the control unit of the imaging apparatus 10 displays, on the first monitor 16, the part of the photographing related information in a state of overlapping with the imaging data of the subject image. The photographing related information with a low confirmation frequency by the user is displayed on the second monitor 40. Examples of the photographing related information with a high confirmation frequency include an elapsed time (TC) from the start of moving image photographing, a remaining battery charge, and the like.

Furthermore, for example, as illustrated in FIG. 12C, the control unit of the imaging apparatus 10 displays the imaging data of the subject image on the first monitor 16, and displays the same photographing related information on both the first monitor 16 and the second monitor 40.

The selection of whether or not the photographing related information is displayed on the first monitor 16, and the selection of the photographing related information to be displayed in a case where the photographing related information is displayed may be performed by the user setting. Additionally or alternatively, the control unit of the imaging apparatus 10 may detect the position and posture of the first monitor 16 with respect to the housing 12, and change the photographing related information displayed on the first monitor 16 based on the detected position and posture of the first monitor 16.

For example, as illustrated in FIG. 7B, when the first monitor 16 is located at the first position, the second monitor 40 is covered by the first monitor 16, so that the user cannot view the second monitor 40. Therefore, when the first monitor 16 is located at the first position, the photographing related information may be displayed on the display screen 16b of the first monitor 16. In addition, in this case, the display on the second monitor 40 may be stopped, that is, the control unit of the imaging apparatus 10 may stop power supply to the second monitor 40.

In addition, for example, as illustrated in FIGS. 9A, 9B, 10A, and 10B, when the first monitor 16 is located at the third position or the fourth position, the second monitor 40 is not covered by the first monitor 16, but is not visible by the user. Specifically, when the first monitor 16 is disposed at the third position or the fourth position, that is, when the display screen 16b faces upward, the user performs photographing work while viewing the display screen 16b of the first monitor 16 facing upward in a state where the imaging apparatus 10 is gripped with both hands so as to be positioned diagonally below the user's head. Thus, since the first monitor 16 becomes an obstacle, the user cannot view the second monitor 40. Therefore, when the display screen 16b of the first monitor 16 faces upward, the photographing related information may be displayed on the display screen 16b of the first monitor 16.

Note that, the position and posture of the first monitor 16 can be detected by various methods. In the case of the present embodiment, a magnetic sensor 46 is used as a position detector of the imaging apparatus 10 for detecting the first monitor 16 present at the first and second positions. As illustrated in FIGS. 7A and 8B, the magnetic sensor 46 is provided in the casing 16a of the first monitor 16, and is, for example, a Hall element or a Giant MagnetoResistance (GMR) element capable of detecting a magnetic field generated from each of first and second magnets 48 and 50 provided in the housing 12. As illustrated in FIG. 7A, the first magnet 48 is provided at a position in the housing 12 near the magnetic sensor 46 when the first monitor 16 is located at the first position. In addition, as illustrated in FIG. 8B, the second magnet 50 is provided at a position in the housing 12 near the magnetic sensor 46 when the first monitor 16 is located at the second position.

As a matter of course, using a sensor other than the magnetic sensor 46, the position and posture of the first monitor 16 can be detected. For example, a contact sensor may be used to detect that the first monitor 16 is located at the first position, that is, the first monitor 16 overlaps the rear surface 12b of the housing 12. In addition, in order to detect a state in which the display screen 16b of the first monitor 16 faces upward, an inclination sensor for detecting the inclination of the first monitor 16 may be used. Alternatively, an angle sensor for detecting the rotation angle of the link arm 32 of the monitor arm mechanism 30 about each of the first and second rotation center lines CL1 and CL2 may be used. Based on the rotation angle detected by the angle sensor, the position and posture of the first monitor 16 with respect to the housing 12 can be calculated.

In addition, in the case of the present embodiment, the imaging apparatus 10 is configured to be able to edit a photographed image and a photographed moving image (that is, the photographed image and the photographed moving image recorded in a storage device (not illustrated) such as a memory card in the housing 12) on the imaging apparatus 10. The user interface (the joystick 42 and the plurality of buttons 44) suitable for the editing work is provided on the rear surface 12b of the housing 12.

In the imaging apparatus 10 according to the present embodiment, as illustrated in FIG. 8C, it is assumed that the user performs editing work in a state where the first monitor 16 is located at the second position. That is, the user executes the editing work by operating the joystick 42 and the plurality of buttons 44 located below the first monitor 16 while viewing the display screen 16b of the first monitor 16 on which the photographed image or the photographed moving image to be edited is displayed. For example, the user operates the joystick 42 with the thumb of the left hand and operates the buttons 44 with the thumb of the right hand while holding the left side surface 12d of the housing 12 with the left hand and holding the right side surface 12e with the right hand. In this manner, by arranging the first monitor 16, the joystick 42, and the plurality of operation buttons 44 on the rear surface 12b of the housing 12, the user can efficiently perform the editing work without greatly changing his/her line of sight.

As illustrated in FIG. 8C, when the first monitor 16 is disposed at the second position by the user, that is, when the first monitor 16 is detected to be located at the second position by the method described above, the imaging apparatus 10 may automatically shift from the photographing mode to the editing mode. For example, when shifting to the editing mode, the imaging apparatus 10 displays, on the first monitor 16 during live-view displaying, the file name of the photographed image or the photographed moving image recorded in the storage device (not illustrated) in the housing 12. Alternatively, the most recently edited photographed image or photographed moving image is displayed on the first monitor 16. Accordingly, the user can easily shift from the photographing work to the editing work or vice versa only by moving the first monitor 16 to the second position or moving the first monitor 16 from the second position. Note that, whether or not to automatically shift from the above-described photographing mode to the editing mode may be determined by user setting. For example, as the user setting, the user may display a menu setting screen on the first monitor 16 by a predetermined operation, and determine the automatic shift from the above-described photographing mode to the editing mode on the basis of the menu setting screen.

In addition, information related to the editing work (editing related information) may be displayed on the second monitor 40. For example, the original moving image before an unnecessary portion is cut may be displayed on the second monitor 40. By using the second monitor 40 for the editing work, the efficiency of the editing work of the user is improved.

Furthermore, functions related to the photographing work may be assigned to the joystick 42 and the plurality of buttons 44 used for the editing work. That is, the intended use of the joystick 42 and the plurality of buttons 44 is not limited to the editing work, and can be used for other work.

For example, as illustrated in FIGS. 9A and 9B, when the first monitor 16 is disposed at the third position overlapping the upper surface 12c of the housing 12, it is difficult for the user to operate the power button 20 provided on the upper surface 12c of the housing 12 as illustrated in FIG. 1. Therefore, any of the plurality of buttons 44 may function as the power button 20. In addition, for example, the joystick 42 and the plurality of buttons 44 may be used for management work of a plurality of photographed image files and photographed moving image files recorded in the storage device (not illustrated) in the housing 12. For example, a file to be deleted may be selected using the joystick 42, and the selected file may be deleted using the plurality of buttons 44.

Furthermore, in the case of the present embodiment, the first monitor 16 is a touch screen monitor. The first monitor 16 may display an operation icon image in which the imaging apparatus 10 executes a corresponding operation when touched by the user. For example, imaging data of a subject image may be live-view displayed, or a photographed moving image being edited may be displayed on a portion of the first monitor 16, and an operation icon may be displayed on the remaining portion.

According to the present embodiment as described above, in the imaging apparatus 10 including the first monitor 16, the first monitor 16 can be made movable to various positions with respect to the housing 12 suitable for photographing, editing, and the like.

Specifically, the first monitor 16 is disposed at the first position overlapping the rear surface 12b of the housing 12. In this case, the user interface such as the joystick 42 provided on the rear surface 12b is covered with the first monitor 16, but the imaging apparatus 10 can perform photographing without use of the covered user interface. Therefore, the first monitor 16 can be increased in size up to a size substantially equal to the rear surface 12b of the housing 12. Therefore, at the time of photographing, the user can confirm the photographed image in detail through the large size first monitor 16. As a result, for example, it is not necessary to convey a large size monitor separate from the imaging apparatus to the photographing place together with the imaging apparatus. In addition, for example, it is not necessary to remove a separate large size monitor from the imaging apparatus. Note that, unlike this, in a case where the first monitor overlaps only a portion of the rear surface of the housing in which the user interface is not provided, the first monitor cannot be enlarged.

Although the embodiments of the present disclosure have been described above with reference to the above-described embodiments, the embodiments of the present disclosure are not limited thereto.

For example, in the case of the above-described embodiments, as the user interface provided on the rear surface 12b of the housing 12, which can be covered by the first monitor 16, the joystick 42 and the plurality of buttons 44 suitable for editing work are provided on the rear surface 12b of the housing 12. However, the embodiments of the present disclosure are not limited thereto. Alternatively or additionally, a jog dial, a touch pad, or the like may be provided as a user interface suitable for editing work.

In addition, in the case of the above-described embodiments, the second monitor 40 is provided as a user interface provided on the rear surface 12b of the housing 12, which can be covered by the first monitor 16. However, the embodiments of the present disclosure are not limited thereto. For example, instead of the second monitor 40, an input apparatus may be provided.

Furthermore, in the case of the above-described embodiment, as illustrated in FIG. 7B, when the first monitor 16 is located at the first position, the user interface such as the joystick 42 and the plurality of buttons 44 provided on the rear surface 12b of the housing 12 is covered by the first monitor 16 and is in an inoperable state. That is, when the first monitor 16 is located at the first position, the user cannot perform the function assigned to the user interface provided on the rear surface 12b of the housing 12. Alternatively, when the first monitor 16 is located at the first position, the imaging apparatus may be configured such that the user can execute the function assigned to the user interface provided on the rear surface 12b of the housing 12 as described below.

FIG. 13 is a rear view of the imaging apparatus in a state where the user interface on the rear surface of the housing is displayed on the first monitor as an icon image.

As illustrated in FIG. 7A, when the magnetic sensor 46 detects that the first monitor 16 is disposed at the first position, as illustrated in FIG. 13, the control unit of the imaging apparatus 10 displays, on the display screen 16b of the first monitor 16 located at the first position, an icon image imitating the user interface provided on the rear surface 12b of the housing 12, that is, an image 100 of the second monitor 40, a joystick icon image 102, and a plurality of button icon images 104 are displayed. In the case of the present embodiment, as can be seen by comparing FIG. 7B and FIG. 13, the image of the user interface displayed on the display screen 16b of the first monitor 16 located at the first position is located on the user interface provided on the rear surface 12b of the housing 12. The contents displayed on the display screen of the second monitor 40 are displayed on the image 100 of the second monitor 40 on the display screen 16b of the first monitor 16. In addition, the same functions as those of the joystick 42 and the plurality of buttons 44 are assigned to the joystick icon image 102 and the plurality of button icon images 104 on the display screen 16b of the first monitor 16. As a result, even when the first monitor 16 is located at the first position, the user can perform the function of the user interface of the joystick 42 and the plurality of buttons 44 provided on the rear surface 12b of the housing 12 by using the joystick icon image 102 and the plurality of button icon images 104 on the display screen 16b of the first monitor 16. On the other hand, when the magnetic sensor 46 detects that the first monitor 16 is not disposed at the first position as illustrated in FIG. 7A, or the magnetic sensor 46 detects that the first monitor 16 is disposed at the second position as illustrated in FIG. 8B, the control unit of the imaging apparatus 10 hides the icon image imitating the user interface displayed on the display screen 16b of the first monitor 16. That is, when the first monitor 16 is disposed at the second position, the icon image imitating the user interface displayed on the display screen 16b of the first monitor 16 is brought into the non-display state.

Whether or not to display, on the display screen 16b of the first monitor 16 located at the first position, an icon image imitating the user interface provided on the rear surface 12b of the housing 12 may be set by the user. In addition, a trigger in the case of displaying may be set by the user. For example, when the first monitor 16 is disposed at the first position as illustrated in FIG. 13 by the user, that is, when the first monitor 16 is detected by the magnetic sensor 46 as illustrated in FIG. 7A, the control unit does not display, on the display screen 16b of the first monitor 16, an icon image imitating the user interface provided on the rear surface 12b of the housing 12.

Furthermore, in the case of the above-described embodiment, as illustrated in FIG. 5, the monitor arm mechanism 30 couples the rear surface 12b of the housing 12 and the first monitor 16. However, the embodiments of the present disclosure are not limited thereto. For example, the monitor arm mechanism 30 may couple a portion other than the rear surface 12b of the housing 12 (for example, the bottom surface) and the first monitor 16.

Regarding the monitor arm mechanism 30, as illustrated in FIG. 5, the monitor arm mechanism 30 includes the link arm 32 that is rotatable about the first and second rotation center lines CL1 and CL2 extending in the left-right direction (Y-axis direction) of the housing 12. That is, the first monitor 16 rotates about the rotation center lines extending in the left-right direction of the housing 12. However, the embodiments of the present disclosure are not limited thereto. For example, the first monitor 16 may be supported by the monitor arm mechanism 30 so as to be rotatable about a rotation center line extending in the normal direction of the display screen 16b.

Furthermore, in the case of the above-described embodiment, the position adjustment mechanism for adjusting the position of the first monitor 16 with respect to the housing 12 to a plurality of positions is the monitor arm mechanism 30. However, the position adjustment mechanism according to the embodiment of the present disclosure is not limited to the monitor arm mechanism.

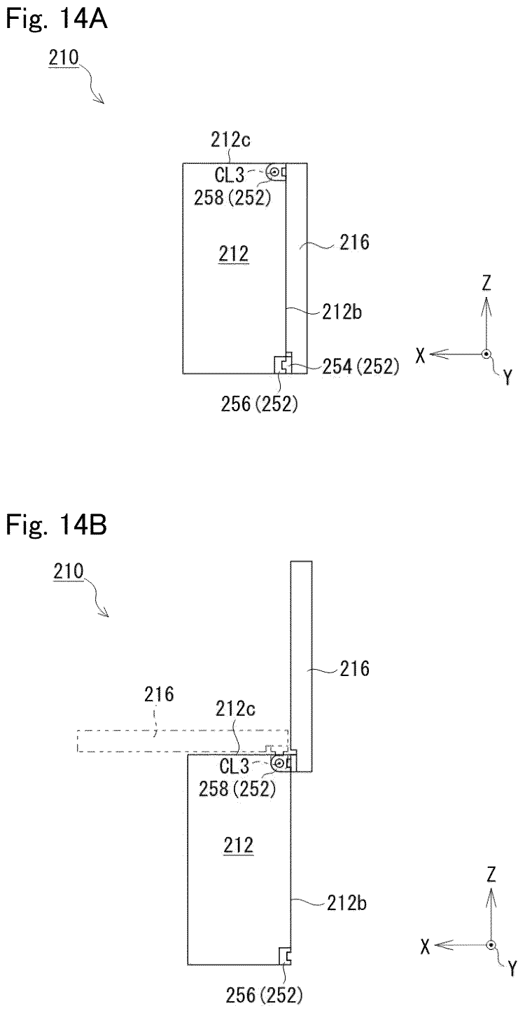

FIG. 14A is a schematic view of the imaging apparatus according to another embodiment in a state where the first monitor is disposed at the first position. In addition, FIG. 14B is a schematic view of the imaging apparatus according to another embodiment in a state where the first monitor is disposed at the second position or the third position.

As illustrated in FIGS. 14A and 14B, in an imaging apparatus 210 according to another embodiment, similarly to the imaging apparatus 10 according to the above-described embodiment, a position of a first monitor 216 with respect to a housing 212 can be adjusted to a plurality of positions. However, in the imaging apparatus 210 of another embodiment, the first monitor 216 may move to another position by being separated from the housing 212 once. That is, the position adjustment mechanism in the imaging apparatus 210 according to another embodiment is different from the monitor arm mechanism 30 of the imaging apparatus 10 according to the above-described embodiment.

Specifically, the imaging apparatus 210 according to another embodiment includes a connector 252 as the position adjustment mechanism. The connector 252 includes a plug 254 provided on the first monitor 216, and first and second receptacles 256 and 258 provided on the housing 212 and electrically and mechanically connected to the plug 254.

One first receptacle 256 is provided in a region below a rear surface 212b of the housing 212. The other second receptacle 258 is provided in a region above the rear surface 212b of the housing 212. In addition, the second receptacle 258 is provided in the housing 212 so as to be rotatable about a rotation center line CL3 extending in the left-right direction (Y-axis direction) of the housing 212.

As illustrated in FIG. 14B, when the plug 254 is connected to the second receptacle 258, the first monitor 216 is disposed at the second position overlapping a portion of the rear surface 212b of the housing 212, or disposed at the third position (two-dot chain line) overlapping an upper surface 212c of the housing 212. That is, when the second receptacle 258 to which the plug 254 is connected is rotated about the rotation center line CL3, the first monitor 216 moves from the second position to the third position or vice versa.

In addition, the position adjustment mechanism may be a mechanism that couples the first monitor and the housing such that the first monitor is slidable (move in parallel) with respect to the housing, or may be a mechanism that couples the first monitor and the housing such that the first monitor is rotatable with respect to the housing about at least one rotation center line.

In addition, in the case of the above-described embodiment, as illustrated in FIG. 7B, the first monitor 16 has a size enough to substantially cover the entire rear surface 12b of the housing 12. However, the embodiments of the present disclosure are not limited thereto. The first monitor may have a size enough to cover a portion of the rear surface of the housing 12.

That is, in a broad sense, the imaging apparatus according to the embodiment of the present disclosure includes: a housing including an upper surface, a front surface, and a rear surface; an imaging sensor that captures a subject image existing in front of the front surface via an optical system to generate imaging data; a first monitor including a display screen; a position adjustment mechanism that movably couples the first monitor to the housing and is capable of adjusting a position of the first monitor with respect to the housing to a plurality of positions; and a user interface provided on the rear surface of the housing, in which the plurality of positions includes a first position where the first monitor overlaps the rear surface of the housing in a state where the user interface is covered and hidden by the first monitor.

As described above, the above-described embodiments have been described as examples of the technology in the present disclosure. For this purpose, the drawings and the detailed description are provided. Therefore, the components described in the drawings and the detailed description may include not only components essential for solving the problem but also components that are not essential for solving the problem in order to exemplify the above technology. Therefore, it should not be immediately recognized that these non-essential components are essential on the basis of the fact that these non-essential components are described in the drawings and the detailed description.

In addition, since the above-described embodiments are intended to exemplify the technology in the present disclosure, various changes, replacements, additions, omissions, and the like can be made within the scope of the claims and equivalents thereof.

The present disclosure is applicable to an imaging apparatus including a monitor.

What is claimed is

1. An imaging apparatus comprising:
a housing including an upper surface, a front surface, and a rear surface;
an imaging sensor configured to capture a subject image existing in front of the front surface via an optical system to generate imaging data;
a first monitor including a display screen;
a position adjustment mechanism configured to movably couple the first monitor to the housing and be capable of adjusting a position of the first monitor with respect to the housing to a plurality of positions; and
a user interface provided on the rear surface of the housing,
wherein the plurality of positions includes a first position where the first monitor overlaps the rear surface of the housing in a state where the user interface is covered and hidden by the first monitor.

2. The imaging apparatus according to claim 1, wherein the plurality of positions includes a second position at which the first monitor overlaps a portion of the rear surface of the housing in a state where the display screen of the first monitor faces rearward and the user interface is exposed.

3. The imaging apparatus according to claim 1, wherein the plurality of positions includes a third position at which the first monitor overlaps the upper surface of the housing.

4. The imaging apparatus according to claim 1, wherein the user interface is provided in a region below the rear surface of the housing.

5. The imaging apparatus according to claim 1, wherein the first monitor has a size enough to cover the entire rear surface of the housing when disposed at the first position.

6. The imaging apparatus according to claim 2, further comprising:
a position detector configured to detect that the first monitor is located at the first position and the second position, and
a control unit configured to control the first monitor,
wherein the control unit:
causes the first monitor to display an icon image imitating the user interface when the first monitor is detected to be located at the first position; and
does not cause the first monitor to display the icon image when the first monitor is detected to be located at the second position.

7. The imaging apparatus according to claim 2, further comprising:
a position detector configured to detect that the first monitor is located at the second position; and
a control unit configured to set to a photographing mode or an editing mode among a plurality of modes,
wherein the control unit
shifts from the photographing mode to the editing mode when the first monitor is detected to be located at the second position.

8. The imaging apparatus according to claim 7, wherein the control unit causes the first monitor to display a file name of the imaging data recorded in a storage device when shifting from the photographing mode to the editing mode.

9. The imaging apparatus according to claim 3, wherein the position adjustment mechanism is a monitor arm mechanism that is provided in the housing and movably supports the first monitor with respect to the housing so that a position of the first monitor is able to be adjusted to at least the first, second, and third positions.
